(19) United States
(12) Patent Application Publication
(10) Pub. No.: US 2018/0048342 A1
(43) Pub. Date: Feb. 15, 2018

(54) Protective Mobile Phone Case with Finger Strap

(71) Applicant: Michael Curcio, Kinnelon, NJ (US)

(72) Inventor: Michael Curcio, Kinnelon, NJ (US)

(21) Appl. No.: 15/677,343

(22) Filed: Aug. 15, 2017

Related U.S. Application Data
(60) Provisional application No. 62/375,181, filed on Aug. 15, 2016.

(51) Int. Cl. H04B 1/3888; H04M 1/02

(52) U.S. Cl. CPC H04B 1/3888; H04M 1/0202

(57) ABSTRACT

A protective mobile phone case with a finger strap is provided. The case includes a front-facing side, a rear-facing side, longitudinally extending sidewalls, and latitudinally extending sidewalls. A pocket disposed on the front-facing side is configured to receive a mobile phone therein and includes an opening for providing access to an interior volume of the pocket. A finger strip mounted through longitudinally extending slits disposed on the rear-facing side includes a pair of recesses for facilitating grasping thereof. The finger strap is configured to secure the rear-facing side to a user's fingers during use. The longitudinally extending sidewalls and the latitudinally extending sidewalls include an inwardly extending lip. The lip, the longitudinally extending sidewalls, and the latitudinally extending sidewalls conjunctively define a groove configured to receive a side edge of a mobile phone.

### CROSS REFERENCE TO RELATED APPLICATIONS

This application claims the benefit of U.S. Provisional Application No. 62/375,181 filed on Aug. 15, 2016. The above identified patent application is herein incorporated by reference in its entirety to provide continuity of disclosure.

### BACKGROUND OF THE INVENTION

The present invention relates to protective cases. More specifically, the present invention relates to a protective case for mobile phones including a finger strap affixed to a rear wall facilitating one-handed use of a mobile phone and self-portrait photography with the mobile phone.

Mobile phones, i.e., smart phones, typically include front-facing touch display screens and front-facing cameras that facilitate self-photography. Some mobile phone users purchase protective cases that partially cover the mobile phone in order to provide protection from inadvertent falls. These cases can be made with any material that is rigid enough to hold its shape and protect the components of the mobile phone, but are often are made of a low-density material so as to minimize the weight and size added to the mobile phone.

A protective case has a rear-facing back portion that is positioned on the opposite side of the display screen of a mobile phone. The exterior surface of the back portion of the case faces away from the mobile phone and toward the palm of the user's hand when the mobile device is held with a typical grip. The exterior surface can be smooth or otherwise have a low friction coefficient that causes the device to be difficult to grip. Some cases have an exterior surface that is textured or coated with a material, such as rubber or leather, which improves the user's ability to grip the case. However, even with a textured or coated case, many users still find it difficult to grip the mobile phone, particularly when operating the mobile phone to take self-portraits, also known as “selfies”, in portrait, landscape, or other orientations.

A wide variety of cases are available for supporting mobile phones. However, conventional cases generally include rigid members that are too bulky and awkward for a user's individual hands and pockets. Also, such designs typically do not provide a user a means for suspending the back portion of the case against the user's fingers and palm, such that the display screen of the mobile phone faces the user, thereby facilitating self-portrait photography with the mobile phone.

### SUMMARY OF THE INVENTION

In view of the foregoing disadvantages inherent in the known types of protective cases for mobile phones now present in the prior art, the present invention provides a new and improved protective case wherein the same can be utilized for providing convenience for the user when utilizing the mobile phone for self-photography.

In one example of the present invention, the protective mobile phone case includes a housing including an open front-facing side, a rear-facing side, a pair of longitudinally extending sidewalls, and a pair of latitudinally extending sidewalls, an upper end and a lower end. A pocket disposed on the open front-facing side includes an interior volume configured to receive a mobile phone therein and an opening for providing access to the interior volume. A rear wall of the rear-facing side includes a pair of longitudinally extending slits disposed centrally between the pair of longitudinally extending sidewalls. A finger strap mounted through the pair of longitudinally extending slits includes an interior side disposed on an interior of the rear wall and a second side disposed on an exterior of the rear wall. The finger strap is configured to secure the rear-facing side of the housing to a user's fingers during use. The pair of longitudinally extending sidewalls and the pair of latitudinally extending sidewalls include a lip extending inwardly towards a center of the interior volume of the housing. The lip and the pair of longitudinally and latitudinally extending sidewalls define a groove configured to receive a side edge of a mobile phone.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective top view of the mobile phone case.

FIG. 2 shows a perspective bottom view of the mobile phone case.

FIG. 3 shows a close-up perspective view of the finger strap of the mobile phone case.

FIG. 4 shows a perspective view of the mobile phone case in use.

### DETAILED DESCRIPTION OF THE INVENTION

Reference is made herein to the attached drawings. Like reference numerals are used throughout the drawings to depict like or similar elements of the mobile phone case. The figures are intended for representative purposes only and should not be considered to be limiting in any respect.

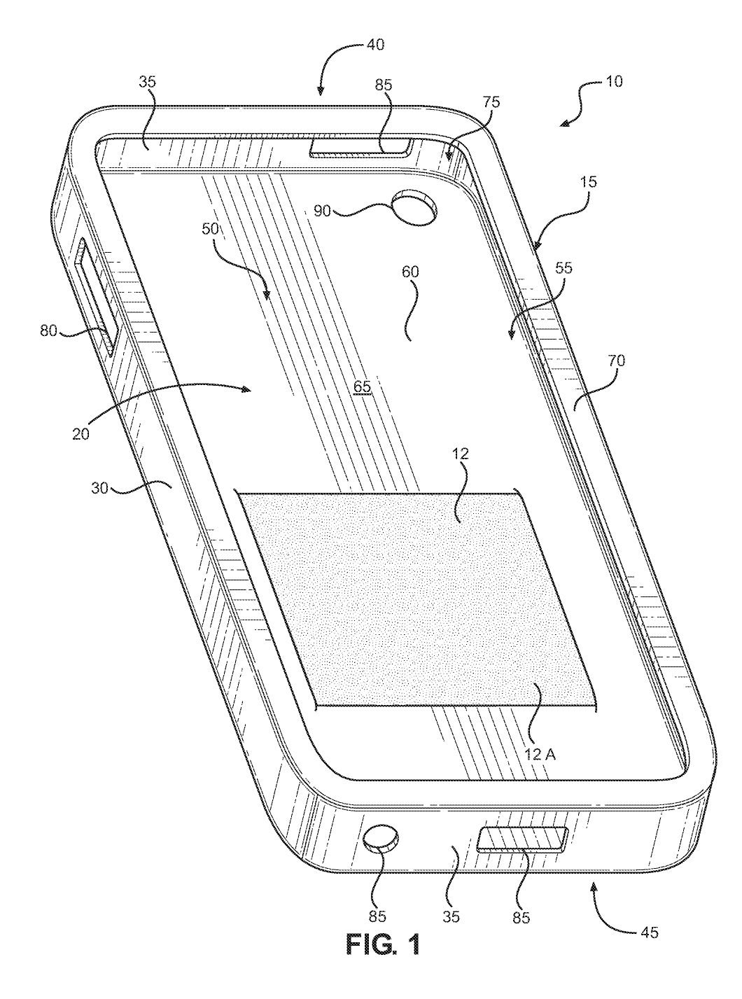

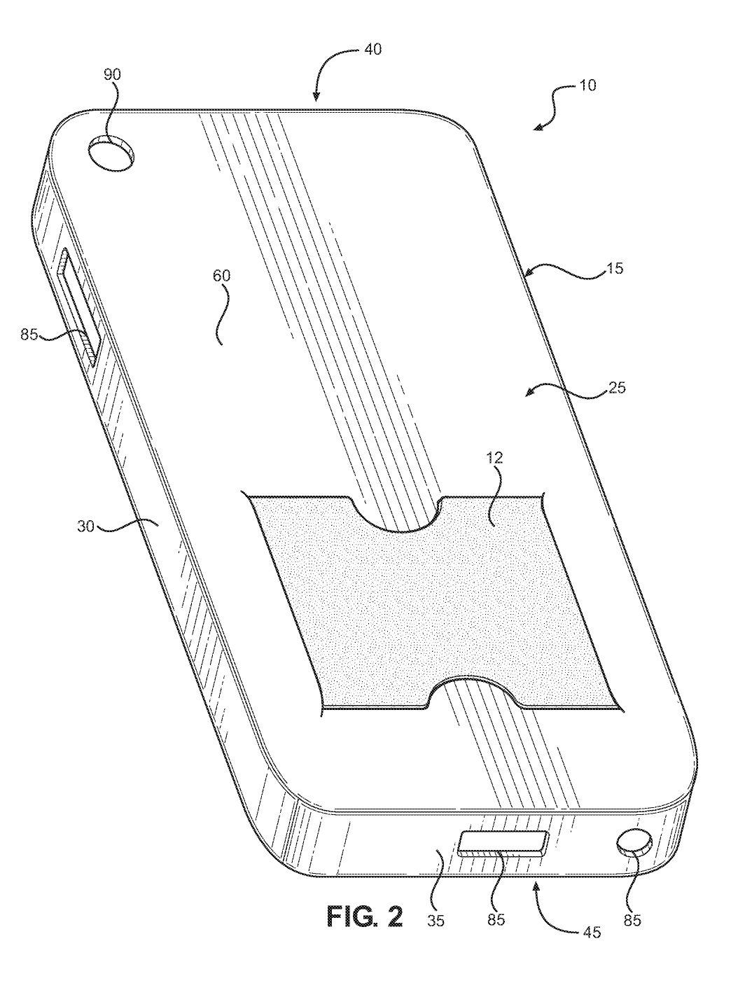

Referring now to FIGS. 1 and 2, there is shown a perspective top view of the mobile phone case and a perspective bottom view of the mobile phone case, respectively. The present invention provides a protective mobile phone case 10 configured to removably receive a mobile phone therein. Further, the mobile phone case 10 includes a finger strap 12 for securing the mobile phone case 10 against a user's fingers, thereby facilitating self-photography with a mobile phone being held in the mobile phone case 10. The mobile phone case 10 comprises a protective housing 15 including an open front-facing side 20, a closed rear-facing side 25, a pair of longitudinally extending sidewalls 30, and a pair of laterally extending sidewalls 35, an upper end 40, and a lower end 45. The housing 15 is composed of a rigid, durable material configured to absorb shock and protect a mobile phone placed therein from damage, such as rubber, plastic, and wood. The open front-facing side 20 includes a pocket 50 including an interior volume sized to receive a mobile phone therein and an opening 55 providing access to the interior volume of the pocket 50. The closed rear-facing side 25 includes a rear wall 60 having a planar interior surface 65 against which a mobile phone can rest flush when the mobile phone is positioned within the pocket 50 of the housing 15.

The pair of longitudinally and latitudinally extending sidewalls 30, 35 extend perpendicularly upwards relative to the rear wall 60 and include a lip 70 extending horizontally inwards, or radially inwards, towards a center of the rear wall 60, such that the lip 70 is parallel relative to the rear wall 60. The lip 70 in conjunction with the pair of longitudinally and latitudinally extending sidewalls 30, 35 define a groove 75 configured to receive the side edges of a mobile phone and secure the mobile phone within the pocket 50. When a mobile phone is inserted into the pocket 50, the lip 70 extends over the edges of the mobile phone, thereby securing the mobile phone inside of the pocket 50.

The pair of longitudinally extending sidewalls 30 include one or more slots 80 that extend vertically along a longitudinal length of the longitudinally extending sidewalls 30. The slots 80 are configured to provide access to an input or an output disposed on the sides a mobile phone that is secured in the case, such as a power button, volume setting, or a display screen button. In the depicted embodiments, the slots 80 are disposed adjacent the upper end 40.

The pair of latitudinally extending sidewalls 35 include one or more apertures 85 configured to provide access to an input or an output of the mobile phone, such as a headphone jack, a power socket, and speaker. In the depicted embodiment, the one or more apertures 85 of the latitudinally extending sidewalls 35 include a circular aperture corresponding to a mobile phone headphone jack, a first elongated rectangular aperture disposed on a latitudinally extending sidewall 35 that corresponds to the mobile phone's power socket, and a second elongated rectangular aperture disposed on an opposing latitudinally extending sidewall 35 that corresponds to the mobile phone's power button. The rear wall 60 includes a cut-out portion 90 corresponding to a mobile phone's camera, such that a user may take photographs with the mobile phone will being held in the case 10.

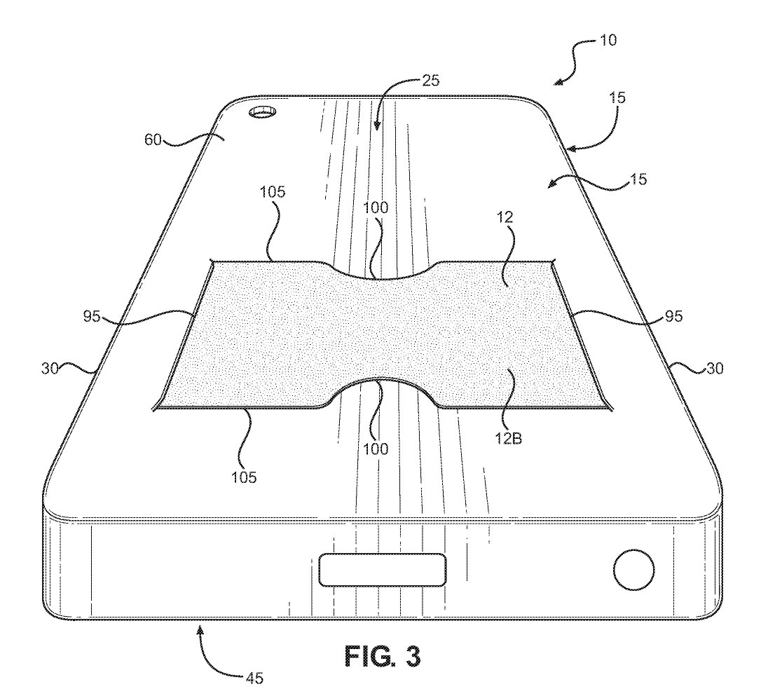

Referring now to FIG. 3, there is shown a close-up perspective view of the finger strap of the mobile phone case. The rear wall 60 of the mobile phone case 10 includes a pair of longitudinally extending slits 95 that are parallel relative to each other and include the same length. In the depicted embodiment, the pair of longitudinally extending slits 95 are linear and disposed below a center of the rear wall 60, extending downwardly towards the lower end 45 of the housing 15. The pair of longitudinally extending slits 95 are configured to retain the finger strap 12 onto the mobile phone case 10.

In the depicted embodiment, the finger strap 12 is a unitary circular band composed of a flexible and elastic material, such as neoprene, spandex, and elastane. The finger strap 12 is integral to the rear wall 60 of the housing 15 and disposed on the lower end 45, centrally between the longitudinally extending sidewalls 30. The finger strap 12 is guided through the pair of longitudinally extending slits 95 and includes an interior side 12A positioned on an interior of the rear wall 60, as shown by FIG. 1, and a rear side 12B positioned on an exterior of the rear wall 60. In this way, the finger strap 12 includes an interior portion, i.e., the interior side 12A, that provides the finger strap 12 structural support and reinforcement when stretching or pulling the finger strap 12 over a user's fingers by engaging with the real wall 60. Additionally, in this way, the interior side 12A helps squeeze a user's fingers against the rear wall 60 when the finger strap 12 is placed around the user's fingers.

The rear side 12B of the finger strap 12 includes pair of recesses 100 disposed on opposing laterally extending edges 105 of the finger strap 12. The pair of recesses 100 extend radially inwardly towards a center of the finger strap, or towards each other. The pair of recesses 100 enable users to grip the laterally extending edges 105 of the finger strap 12 in order to lift the finger strap 12 and slide their fingers thereunder. In the depicted embodiment, the pair of recesses 100 are semicircular in shape and disposed along a center of each of the laterally extending edges 105, such that the pair of recesses 100 are symmetrical about a longitudinal axis and a latitudinal axis of the finger strap 12.

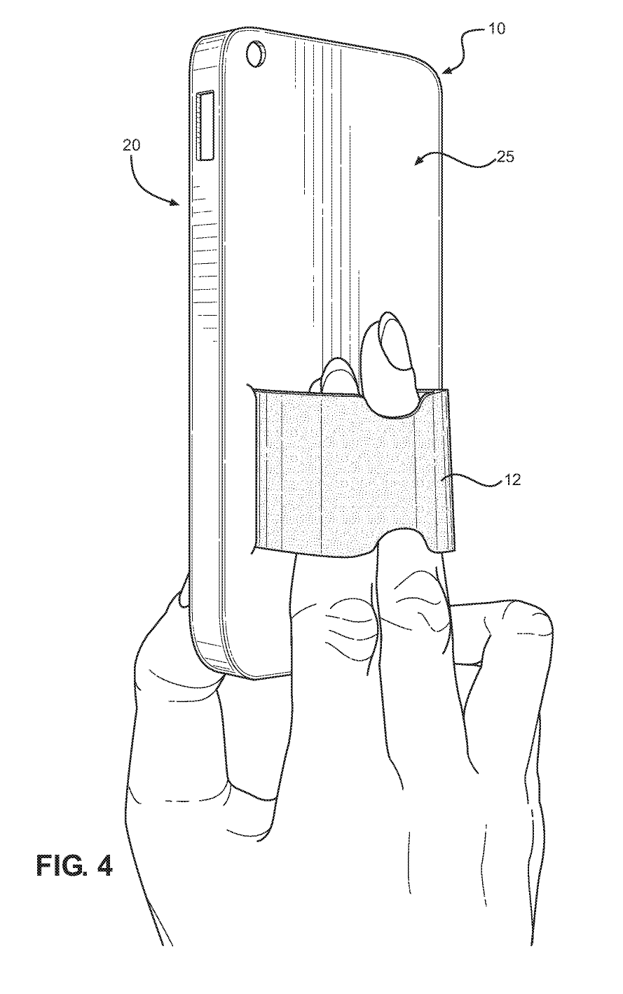

Referring now to FIG. 4, there is shown a perspective view of the mobile phone case in use. The finger strap 12 enables users to secure the rear-facing side 25 of the mobile phone case 10 to their fingers such that the front-facing side 20 faces away from their hand. This in turn enables users to more easily maneuver and control the directionality of a mobile phone secured in the mobile phone case 10. In this way, a user may easily position the mobile phone to face them, such that they may engage in self-photography with a front-facing camera of the mobile phone. The finger strap 12 secures the mobile phone to a user's hand, eliminating the need to awkwardly clutch the mobile phone or an apparatus thereon with an entire hand or fingers in order to reposition the mobile phone when taking self-photographs.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A mobile phone case, comprising:
a housing including an open front-facing side, a rear-facing side, a pair of longitudinally extending sidewalls, a pair of latitudinally extending sidewalls, an upper end, and a lower end;
the open front-facing side including a pocket having an interior volume configured to receive a mobile phone therein, the pocket including an opening for providing access to the interior volume;
the rear-facing side including a rear wall having a pair of longitudinally extending slits disposed below a central latitudinal axis of the rear wall;
wherein the pair of longitudinally extending slits are disposed centrally between the pair of longitudinally extending sidewalls;
a finger strap mounted through the pair of longitudinally extending slits, the finger strap including an interior side disposed on an interior of the rear wall and a second side disposed on an exterior of the rear wall, the finger strap configured to secure the rear-facing side of the housing to a user's fingers;
the pair of longitudinally extending sidewalls and the pair of latitudinally extending sidewalls including a lip extending radially inwardly towards a center of the interior volume, wherein the lip, the pair of longitudinally extending sidewalls, and the pair of latitudinally extending sidewalls define a groove configured to receive a side edge of a mobile phone.

2) The mobile phone case of claim 1, wherein the rear wall includes a cut-out portion corresponding to a camera of a mobile phone.

3) The mobile phone case of claim 2, wherein at least one sidewall of the pair of longitudinally extending sidewalls includes one or more slots extending vertically along a longitudinal length thereof.

4) The mobile phone case of claim 3, wherein at least one sidewall of the pair of latitudinally extending sidewalls includes one or more apertures.

5) The mobile phone case of claim 4, wherein the one or more apertures includes any one of a circular aperture, a first elongated rectangular aperture, and a second rectangular elongated aperture.

6) The mobile phone case of claim 1, wherein the pair of longitudinally extending slits are linear and symmetrically aligned about a longitudinal axis of the rear wall, such that each longitudinally extending slit includes the same length.

7) The mobile phone case of claim 1, wherein the rear wall includes a planar interior surface.

8) The mobile phone case of claim 7, wherein the lip is parallel relative to the rear wall.

9) The mobile phone case of claim 1, wherein the finger strap is composed of a flexible and elastic material.

10) The mobile phone case of claim 1, wherein the finger strap includes a first recess disposed on a first laterally extending edge of the finger strap and a second recess disposed on an opposing second laterally extending edge, the first recess and the second recess each extending inwardly towards a center of the finger strap.

11) The mobile phone case of claim 10, wherein the first recess is disposed along a center of the first laterally extending edge and the second recess is disposed along a center of the opposing laterally extending edge, such that the first recess and the second recess are symmetrical about a longitudinal axis of the finger strap.
